(19) United States
(12) Patent Application Publication
(10) Pub. No.: US 2005/0069100 A1
(43) Pub. Date: Mar. 31, 2005

(54) Method for transmission of multimedia data between at least one communication device and at least one computer system

(76) Inventor: Gregor Scholl, Dortmund (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/944,104

(22) Filed: Sep. 17, 2004

(30) Foreign Application Priority Data
Sep. 26, 2003 (DE) 10344772.5

(51) Int. Cl. H04M 11/00

(52) U.S. Cl. 379/88.13

(57) ABSTRACT

The invention relates to a method for transmission of multi-media data (2) between at least one communication device (1.1 . . . 1.x) and at least one computer system (4.1 . . . 4.x), where a number of applications, preferably TAPI applications (9) can be executed on the computer system (4.1 . . . 4.x) and the communication device (1.1 . . . 1.x) and the computer system (4.1 . . . 4.x) communicate via a network (3).

The outstanding feature of the method is that the multimedia data (2) is transmitted directly in the form of unprocessed raw data to the telephony applications (9) of the computer system (1.1 . . . 1.x).

### CROSS REFERENCE TO RELATED APPLICATIONS

This application claims priority to the German application No. 10344772.5, filed Sep. 26, 2003 and which is incorporated by reference herein in its entirety.

### FIELD OF INVENTION

The invention relates to a method for transmission of multimedia data between at least one communication device and at least one computer system, where a number of applications, preferably TAPI applications (=telephony applications), can be executed on the computer systems and the communication device and the computer systems communicate over a network.

### BACKGROUND OF INVENTION

The integration or combination of telephony applications in/with computer systems—e.g. a Personal Computer, PC—is generally known and is also referred to by experts as “Computer Telephony Integration”, CTI.

With CTI one or more computer systems are connected via a packet-oriented network, generally what is known as a Local Area Network, LAN to one or more communication devices. In the computer system, for communication or data transmission with or to the telephony applications there is what is known as a TAPI (Telephony Application Programming Interface).

With TAPI in a second version, TAPI 2.x, functions such as call setup, telephone conferences or call forwarding can be executed, where, by using TAPI 2.x, audio signals such as voice signals for example are converted with the aid of what are known as wave devices into audio files, which are then routed to the telephony applications. The term “Wave Devices” is taken to mean especially virtual devices which the operating system uses.

So that VOIP (VOIP=Voice over Internet Protocol) applications, such as voice mail and/or video streams can be executed, the multimedia needed have previously been transmitted with a TAPI in a third version, TAPI 3.x. With TAPI 3.x the data is routed to the telephony applications via one or more complex interfaces. From TAPI 3.x onwards, that is in a third version, it is now possible, in addition to using classic telephone services, to access data-bases and access audio and video streams.

The implementation of TAPI 3.x however means an increased outlay in hardware and software in a number of components of the computer system and is this simultaneously associated with increased costs of the overall system. Combining TAPI 2.x with TAPI 3.x in order to save money is not possible since TAPI 2.x and TAPI 3.x are not compatible with each other.

### SUMMARY OF INVENTION

The object of the invention is thus to find a new method for transmission of multimedia data between at least one communication device and at least one computer system, which unlike TAPI 3.x, can do without additional complex Interfaces and routes the multimedia data with the aid of a TAPI 2.x interface to the telephony applications on the computer system, without converting the multimedia data with the aid of wave devices when doing so.

The object of the invention is achieved by the claims.

The invention works on the assumption that it is not necessary, as previously with TAPI 2.x, to convert the multimedia data with wave devices and that it is thus not necessary, as with TAPI 3.x, to first route the multimedia data via interfaces to the telephony application, if the multimedia data is to be directed in the form of unprocessed raw data directly to the telephony applications. If the data is transferred directly to the telephony applications, a TAPI 2.x interface can also be used for this purpose. In addition TAPI 2.x applications are then also in the position to process multimedia data.

In line with these considerations, the method in accordance with the invention makes provision for transmission of multimedia data between at least one communication device—e.g. public and/or private line equipment, also referred to as PBX (Private Branch Exchange or Public Branch Exchange) or as a telephone system—and at least one computer system—for example a Personal Computer, PC—on which a number of applications, preferably TAPI applications (=telephony applications), can be executed, and where the communication device and the computer system communicate via a packet-oriented network communicate, to be designed so that the multimedia data is transferred in the form of unprocessed raw data directly to the telephony applications of the computer system.

Through this method a media streaming functionality is provided, without a TSP (TSP=Telephony service provider) driver and a TAPI 3.x having to be implemented.

Previously with an implementation of TAPI 2.x the data was transmitted indirectly via a conversion of the multimedia data through wave devices. For TAPI 2.x drivers it is necessary to edit the PBX multimedia data so that a virtual wave device can provide the data. This virtual device is also to be implemented in the form of software so that is corresponds to the standard of the operating system, mostly the Windows standard.

For TAPI 3.x drivers too it is necessary, as described above, to edit the multimedia data. Here the telephony driver must make the multimedia Interfaces available directly. In addition one application must satisfy these TAPI 3.x interfaces.

It is useful if, for transmission of the multimedia data an ESL (=Extended Services Line) interface is used. The ESL interface is a TAPI expansion via which proprietary information, such as for example charge codes or key combinations of the terminals, can be exchanged. There has thus far not been any exchange of multimedia data via the ESL interface.

It is further advantageous, if for communication between the communication device and the computer system a Local Area network, LAN, is used. The use of this type of packet-oriented network allows high transmission speeds of around 10 Gigabit/second over a network area extending to around 10 kilometers.

It is further useful for the TCP/IP protocol to be used as the transport protocol for the LAN. In this case the implementation outlay and the space requirements can be reduced and simultaneously various services such as Telnet, FTP and SMTP, which are based on TCP/IP, can be used.

Video and/or voice streams in particular are considered as multimedia data. It is advantageous for the method if the multimedia data are extracted from the network with IP sockets. This data is then routed to the applications for which it is intended with the Extended Services Line.

The method makes provision for routing the raw data of the communication device to the TAPI applications in the form in
which it is extracted from the LAN. The packet size in this case can be around 200 bytes.

An exemplary embodiment with further advantages and embodiments of the invention is explained in more detail below on the basis of the drawing.

In detail, the single figure shows:

### BRIEF DESCRIPTION OF THE DRAWING

FIG. 1: a structure diagram to represent the method in accordance with the invention within a network.

### DETAILED DESCRIPTION OF INVENTION

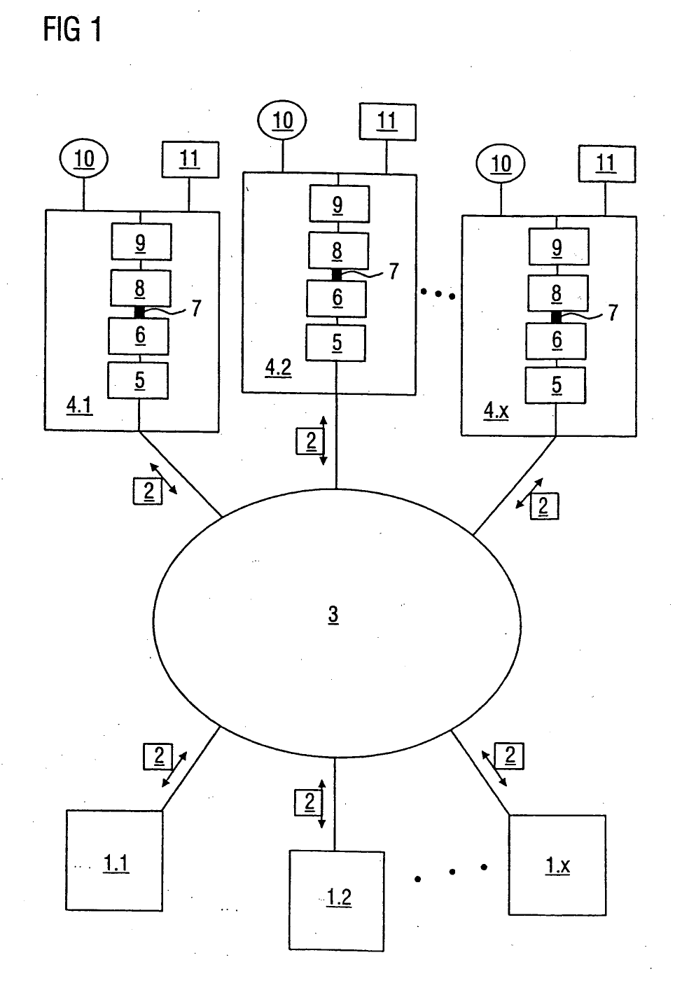

FIG. 1 shows a network 3, over which a number of computers 4.1 to 4.x communicate with a number of communication devices 1.1 to 1.x. Multimedia data, for example voice mail, video streams, is to be exchanged between the computers 4.1 to 4.x and the communication devices 1.1 to 1.x. The data stream of the multimedia data is represented by the double-ended arrows with the reference character 2. Using the new method the data streams of the multimedia data 2 are to be routed to the TAPI 2.x applications 9 which are executed by the operating system of the computer 4.1 to 4.x. The multimedia data, for example voice mail, video streams, is then made audible and visible via the hardware components of the computer 4.1 to 4.x, such as loudspeaker 10 and monitor 11, for the computer user. But there is also the option of storing the multimedia data.

Data packets are extracted from this data stream 2 on data coupling/uncoupling 6 containing multimedia information, such as for example video and/or audio. This data is then transferred directly to the Extended Services Lines 7.

Through the Extended Services Lines 7 the multimedia data is signaled to the TAPI 2.x applications 9. Now the multimedia data can be processed by the applications in suitable form.

A media streaming functionality is provided by the method, without a TSP for TAPI 3.x and TAPI 3.x applications having to be implemented on the computers 4.1 to 4.x.

Previously for implementation TAPI a so-called Telephony Service Provider, TSP, has always been assigned. TAPI is the interface which the Windows platform provides for application developers. The TSP is that software component, which communicates with the communication device, PBX. The TSPs are made available by the providers of the PBX. These TSPs communicate with the PBX and simultaneously provide an interface for TAPI. Windows uses these TSPs after suitable configuration. In TAPI the information of all TSPs is combined into a TAPI interface which is the same for all applications lying below it.

Overall the invention provides a method with which multimedia data can be transmitted using TAPI 2.x between at least one communication device and at least one computer system without using wave devices to do so. The new method also avoids a cost-intensive implementation of TAPI 3.x.

Naturally the features of the invention stated in this document can be used, not just in the combination specified, but also in other combinations or on their own, without departing from the framework of the invention.

In the text of the application, the description of the Figure and the patent claims the following abbreviations are used:
CTI Computer telephony integration
FTP File Transfer Protocol
IP Internet Protocol
LAN Local Area Network
PBX Private Branch Exchange
SMTP Simple Mail Transfer Protocol
TAPI Telephony Application Programming Interface
TSP Telephony Service Provider
VOIP Voice-Over-Ip

In addition the following reference characters are used in the description of the figure and the patent claims:
1.1 to 1.x Communication device 1 to communication device x
2 Data streams with multimedia data
3 Network
4.1 to 4.x computer system 1 to computer system x
5 VOIP interface/Direct Show Filter
6 Data coupling/data uncoupling
7 Extended services line
8 Tapi 2.x interface
9 Tapi 2.x application
10 Loudspeaker
11 Monitor

1-7. (cancelled)

8. A method for transmission multimedia data between a communication device and a computer system, wherein telephony applications are executed on the computer system, the method comprising:
performing a communication between the communication device and the computer system via a network; and
transmitting the multimedia data in the form of unprocessed raw data directly to the telephony applications of the computer system.

9. The method in accordance with claim 8, wherein an ESL interface is used for transmission of multimedia data.

10. The method in accordance with claim 8, wherein a packet-oriented network is used for communication between the communication device and the computer system.

11. The method in accordance with claim 9, wherein a packet-oriented network is used for communication between the communication device and the computer system.

12. The method in accordance with claim 10, wherein the packet-oriented network is operated in accordance with the TCP/IP protocol.

13. The method in accordance with claim 8, wherein the multimedia data use video and/or voice streams.

14. The method in accordance with claim 9, wherein the multimedia data use video and/or voice streams.

15. The method in accordance with claim 10, wherein the multimedia data use video and/or voice streams.

16. The method in accordance with claim 12, wherein the multimedia data use video and/or voice streams.

17. The method in accordance with claim 8, wherein the multimedia data is extracted from the network with IP sockets.

18. The method in accordance with claim 9, wherein the multimedia data is extracted from the network with IP sockets.

19. The method in accordance with claim 10, wherein the multimedia data is extracted from the network with IP sockets.

20. The method in accordance with claim 12, wherein the multimedia data is extracted from the network with IP sockets.

21. The method in accordance with Claim 13, wherein the multimedia data is extracted from the network with IP sockets.

22. The method in accordance with claim 8, wherein the multimedia data is taken from individual data packets and then made available to the ESL interfaces.

23. The method in accordance with claim 9, wherein the multimedia data is taken from individual data packets and then made available to the ESL interfaces.

24. The method in accordance with claim 10, wherein the multimedia data is taken from individual data packets and then made available to the ESL interfaces.

25. The method in accordance with claim 12, wherein the multimedia data is taken from individual data packets and then made available to the ESL interfaces.

26. The method in accordance with claim 13, wherein the multimedia data is taken from individual data packets and then made available to the ESL interfaces.
